(19) United States
(12) Patent Application Publication
(10) Pub. No.: US 2005/0166192 A1
(43) Pub. Date: Jul. 28, 2005

(54) Run time compiler system and method

(76) Inventors: Michael P. Polcha, Lovettsville, VA (US); Andrew J. Polcha, Lovettsville, VA (US)

Correspondence Address: EDELL, SHAPIRO & FINNAN, LLC, 1901 RESEARCH BOULEVARD, SUITE 400, ROCKVILLE, MD, 20850, US

(21) Appl. No.: 10/983,160

(22) Filed: Nov. 8, 2004

Related U.S. Application Data
(60) Provisional application No. 60/517,384, filed on Nov. 6, 2003.

(51) Int. Cl. G06F 15/00

(52) U.S. Cl. 717/140

(57) ABSTRACT

A method for providing a run-time compiler function in a computer includes the steps of: receiving an executable code which includes a compiler; creating plural objects from portions of the executable code based on the compiler; storing the objects in memory data segments; and linking the stored objects to one another.

### FIELD

Embodiments of the present invention may relate to computer processing techniques. More specifically, embodiments of the present invention may relate to a compiler.

### BRIEF DESCRIPTION OF THE DRAWINGS

The foregoing and a better understanding of the present invention will become apparent from the following detailed description of arrangements and example embodiments and the claims when read in connection with the accompanying drawings, all forming a part of the disclosure of this invention. While the foregoing and following written and illustrated disclosure focuses on disclosing arrangements and example embodiments of the invention, it should be clearly understood that the same is by way of illustration and example only, and the invention is not limited thereto.

The following represents brief descriptions of the drawings in which like reference numerals represent like elements and wherein:

FIG. 1 is a block diagram of a computer system according to an example embodiment of the present invention;

FIG. 2 is a block diagram of a memory according to an example embodiment of the present invention;

FIG. 3 is a view of an object according to an example embodiment of the present invention; and

FIG. 4 is a view of a plurality of linked objects according to an example embodiment of the present invention.

### DETAILED DESCRIPTION

In the following detailed description, like reference numerals and characters may be used to designate identical, corresponding or similar components in differing figure drawings. Further, arrangements and embodiments of the present invention may be shown in block diagram form in order to avoid obscuring the invention, and also in view of the fact that specifics with respect to implementation of such block diagram arrangements may be dependent upon the platform within which the present invention is to be implemented. That is, the specifics are well within the purview of one skilled in the art. Where specific details are set forth in order to describe example embodiments of the invention, it should be apparent to one skilled in the art that the invention can be practiced without these specific details.

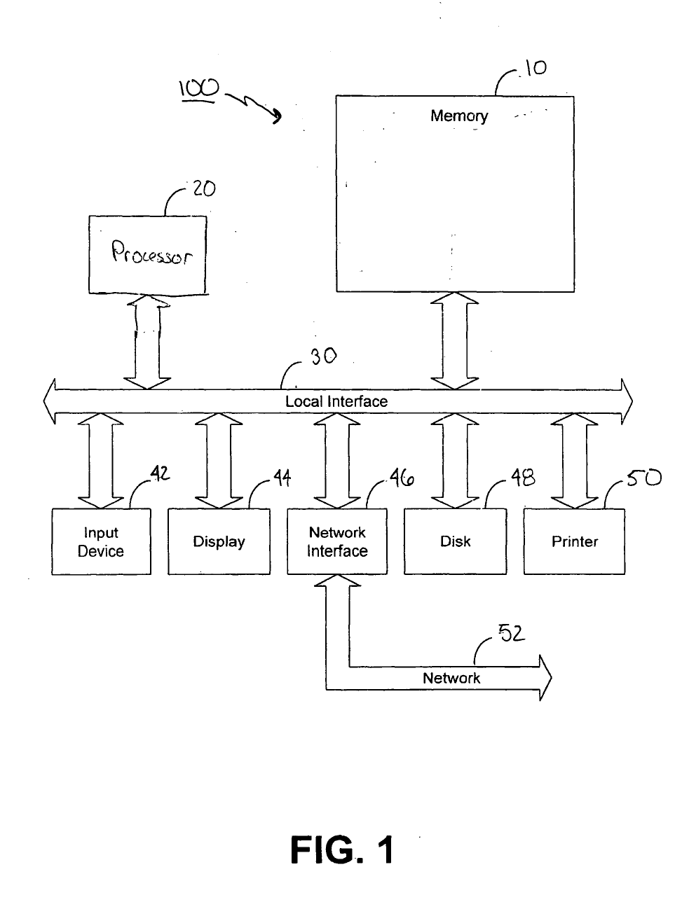

FIG. 1 is a block diagram of a computer system according to an example embodiment of the present invention. Other embodiments and configurations are also within the scope of the present invention. More specifically, FIG. 1 shows a computer system 100 that may include a memory 10 coupled to a processor 20 by a local interface 30, such as a bus. The processor 20 may be a digital processor or other type of circuitry configured to run executable programs by processing and executing the instructions of the executable program. The processor 20 may communicate to and drive other elements within the system 100 via a local interface 30, which can include one or more buses. Furthermore, an input device 42, for example, a keyboard, a switch, a mouse, and/or other type of interface, can be used to input data from a user of the system 100, and screen display 44 or a printer 50 can be used to output data to the user. A disk storage mechanism 48 can be connected to the local interface 30 to transfer data to and from a nonvolatile disk (e.g., magnetic, optical, etc.). The system 100 can be connected to a network interface 52 that allows the system 100 to exchange data with a network (not shown).

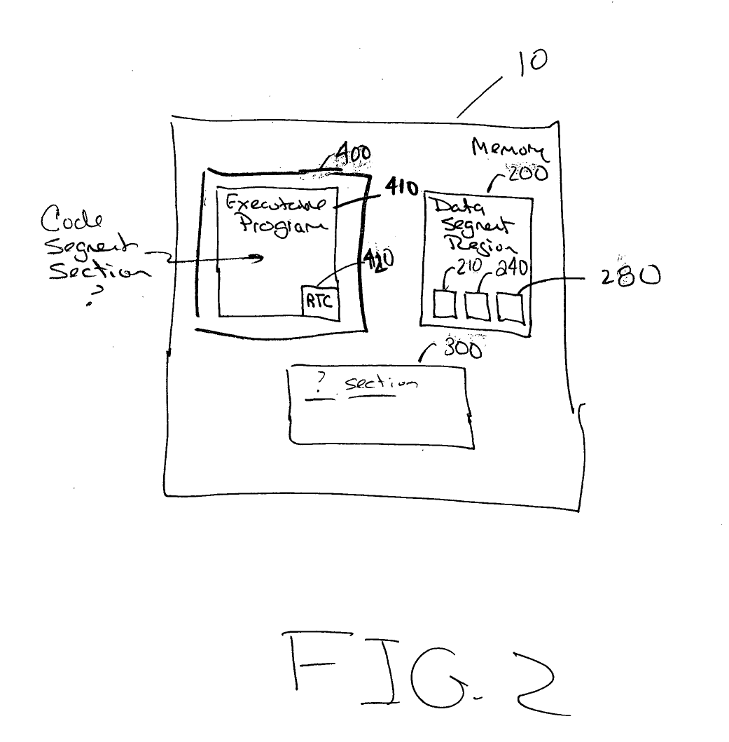

FIG. 2 is a block diagram of a memory (or memory device) according to an example embodiment of the present invention. Other embodiments and configurations are also within the scope of the present invention. More specifically, FIG. 2 shows that memory space may be divided into a data segment section 200, section 300 and an executable section 400.

The executable section 400 may store an executable program (such as a spreadsheet application, for example) 410. The executable program 410 may include a run-time compiler 420 imbedded within (or considered part of) the executable program 410. As will be explained below in greater detail, the data segment section 200 may store various blocks of data. Each block of data will be shown and described as being a contiguous block. However, one skilled in the art would understand that a memory block need not be a contiguous block of data.

The executable program 410 may be formed and stored in a well-known manner. That is, a specific application, such as a spreadsheet application, may be initially loaded into the computer system 100 by the disk unit 48. A compiler (not shown) may generate the executable program 410 by translating a source program from the disk into a form compatible with the processor 20. In this regard, the compiler may translate the source program into the executable program 410, which may then be executed by processor 20. It is not necessary for the executable program 25 to have been compiled by any compiler.

FIG. 2 also shows an object 1 file 210, and object 2 file 240 and an object 3 file 280. As will be described below, the compiler 420 embedded within the executable program 410 creates the objects 210, 240 and 280 that are stored within the data segment section 200. Each of the objects 210, 240, 280 may include executable code (as the operation function) so that the entire executable program 410 does not need to be reinterpreted when a data value changes.

The objects 210, 240 and 280 are linked list objects (i.e., non-identical objects) with pointers to the next objects. These objects will be executed by referencing data within the blank section 300 in order to get a desired output. The objects 210, 240 and 280 are created at the time of first interpretation of the executable program 410. The objects may not be changed during subsequent operations of the executable program 410. However, the data within the blank section may change based on the executed objects.

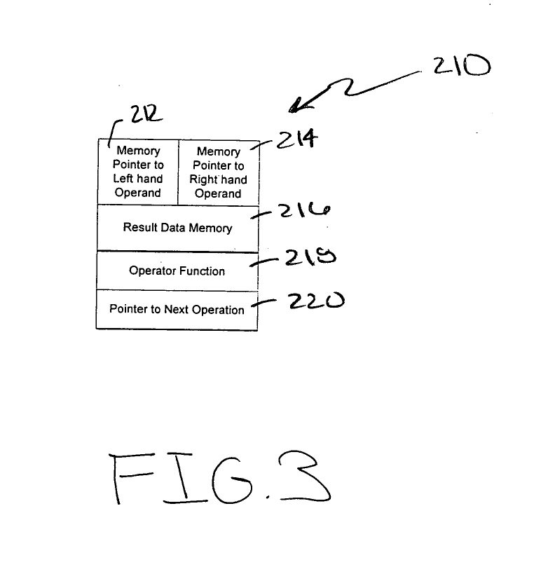

FIG. 3 shows a view of an object according to an example embodiment of the present invention. Other objects and embodiments are also within the scope of the present invention. More specifically, the object 210 includes various regions which are shown in a block form. As described above, it is not necessary that each of the regions of the object 210 are provided within a contiguous set of memory. The object 210 includes a memory pointer to left hand operant section 212, a memory point to right hand operant section 214, a result data memory 216, an operator function 218 and a pointer to next operation 220. These various regions of the object 210 may be used to provide a link best of object within the data segment region 200 from memory 10.

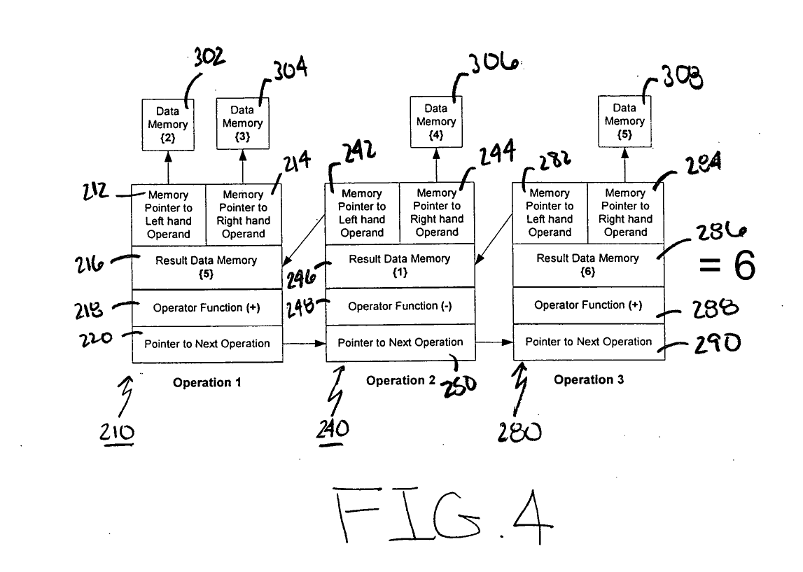

FIG. 4 is a view of a plurality of linked objects 210, 240 and 280 according to an example embodiment of the present invention. Other embodiments are also within the scope of the present invention.

Embodiments of the present invention may implement a compiler (such as compiler 420) in an executable program 410 such as a spreadsheet application. The compil 34 420 may compile a machine code routine for each cell that contains a formula.

That is, during the initial interpretation of the executable program 410, the various objects such as objects 210, 240 and 280 may be created. When subsequent data values change within the application running on the computer system, then it may be unnecessary for the executable program to execute again. That is, operations within a computer system 210, 240 and 280 may occur within the objects in the section 300. This may be illustrated by a methodology such as a mathematical expression of 2+3−4+5. This may be evaluated by performing the operations:
2+3=5
5−4=1
1+5=6

That is, the above mathematical expression is a series of separate operations. Each operation has a left operand, an operator and a right operand. The result of one operation may become the left hand operand of the next operation. This may continue until the last operation is computed which in turn yields the result of the whole expression. FIG. 5 may be shown to show these three operations of the above mathematical expression.

As discussed above, the object 210 includes memory pointer to left hand operand 212, memory pointer to right hand operand 214, result data memory 216, operator function 218 and pointer to next operation 220. Similarly, the object 240, which corresponds to the second operation includes memory pointer to left hand operand 242, memory pointer to right hand operand 244, result data memory 246, operator function 248 and pointer to next operation 250. Still similarly, the object 280, which corresponds to the operation three discussed above, includes memory pointer to left hand operand 282, memory pointer to tight hand operand 284, result data memory 286, operator function 288 and pointer to next operation 290. The objects 210, 240 and 280 may be created during the interpretation of the executable program, such as the spreadsheet application in this example. The first operation 1 is the mathematical operation 2+3. The values of 2 and 3 are stored within data memory 302 and 304 which are provided within the section 300 of the memory 10. These values within the memory 300 may change over time depending on the data input by the user into the spreadsheet operation. When the spreadsheet application begins execution, the memory pointer to left hand operand section 212 points to the data memory 302 which in this case includes the value 2. Additionally, the memory point to right hand operand 214 points to the data memory 304 which in this case corresponds to the value 3. The operator function 218 within the object 210 corresponds to a mathematical plus operation. According, the result data memory section 216 stores a value of 5, corresponding to the addition of the value within the data memory section 302 and the data memory section 304. As shown in FIG. 4, the pointer to next operation section 220 includes a value to point to the next operation, corresponding to the object 240. In object 240, the memory pointer to left hand operand section 242 points to the previous resulted data memory section 216 within the object 210. As indicated above, this value stores a value corresponding to 5. The second operation includes a subtraction of 4 from the previous result value. Therefore, the memory pointer to right hand operant 244 points to the data memory section 306, which stores a value of 4 as previously input by the user. The operator function section 248 corresponds to a minus function and therefore the resulting data memory section 246 stores a value of 1, resulting from the subtraction of 4 from the previous result data memory section 216. The pointer to next operation section 250 points to the object 280. The object 280 corresponds to an addition of 5 to the previously resulting data, that is the memory pointer to left hand operand 282 points to the previous data result memory section 246. The memory pointer to right hand operand section 284 points to the data memory section 308. As such, the system performs a plus function based on a value stored within an operator function 288 and the value within the data memory section 308. The resulting data value of 6 is stored within the result data memory section 286. In this case, the pointer to next operation section 290 may contain an end of file or pointer to the end of execution of the file. As such, the value of 6 may be obtained based on the above described mathematical expression.

As such, the mathematical expression may be provided through a linked list of object files including appropriate pointers to next operations as well as pointers to various operands which may be stored within a data section 300. Many different operation data structures can be linked together in a similar manner as shown in FIG. 4. Arrays of operation data structures can be created to represent any mathematical expression. The result of mathematical expressions may be obtained by appropriately linking the array of operation data structures while performing each operation. Embodiments of the present invention may provide different ways to implement actual operation. That is, each operation data structure may contain an operator function that performs the required operation. Polymorphism techniques may also be used to create a set of operation objects that can perform each of the different fundamental mathematic operations. In the examples shown in FIG. 4, each of the operand pointers points to a constant value stored in memory, such as the value stored in data memory section 302, 304, 306 and 308. Embodiments of the present invention may utilize operand pointers to point to valuable storage areas in memory. By modifying the pointer values to point to program variables, the expressions can be used to process dynamic data in real time. Additionally, mathematical parsers or interpreters can be constructed to analyze symbolic mathematical expressions and build an array of these operation structures. A system that employs this technology can compute the results of dynamic mathematical expressions inputted during run time at execution speeds comparable to compiled software applications incorporating fixed expressions. Embodiments of the present invention may be adapted to many different applications not limited to mathematical problems. Applications including parallel processing may also benefit from this technology.

The executable program may be implemented in software, can be stored and transported on any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (magnetic), a read-only memory (ROM) (magnetic), an erasable programmable read-only memory (EPROM or Flash memory) (magnetic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium. As an example, the executable program may be magnetically stored and transported on a conventional portable computer diskette.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

1. A method comprising:
receiving an executable file including a compiler; and
creating a plurality of objects of portions of the executable file based on the compiler.

2. The method of claim 1, further comprising storing the plurality of objects in a data segment section of a memory.

3. The method of claim 2, wherein the executable file is included in an executable file section of the memory, the executable file section being different than the data segment section. (Need to distinguish the different sections of the memory.)

4. The method of claim 1, wherein creating the plurality of objects comprises: creating a plurality of non-identical objects linked together by a plurality of pointers. (Need numerous claims directed toward how and why the objects are created.)

5. The method of claim 1, wherein creating the plurality of objects comprises interpreting portions of the executable program to create the plurality of objects.

6. The method of claim 1, wherein creating the plurality of objects comprises forming the objects during a first execution of the executable file. (And maybe a claim that the objects are only created once)

7. The method of claim 1, further comprising executing the plurality of objects (and without recreating the objects).

8. The method of claim 1, wherein the plurality of objects represent a sequence of operations.

9. The method of claim 1, wherein the plurality of objects comprises a linked list of operations (or represent an executable entity).

10. The method of claim 1, wherein each of the objects comprises (and list of what is in the objects such as an operator function/executable code, and pointers to Left operand, Right operand and next object).

11. A method comprising:
creating a first object from an executable file;
creating a second object from the executable file; and
linking the first object to the second object.
